(19) United States
(12) Patent Application Publication
(10) Pub. No.: US 2016/0227243 A1
(43) Pub. Date: Aug. 4, 2016

(54) VIDEO ENCODING APPARATUS AND METHOD

(71) Applicant: Electronics and Telecommunications Research Institute, Daejeon (KR)

(72) Inventor: Seung-Hyun CHO, Daejeon (KR)

(21) Appl. No.: 15/013,280

(22) Filed: Feb. 2, 2016

(30) Foreign Application Priority Data
Feb. 4, 2015 (KR) 10-2015-0017599

(51) Int. Cl. H04N 19/593; H04N 19/176; H04N 19/119

(52) U.S. Cl. CPC H04N 19/593; H04N 19/119; H04N 19/176

(57) ABSTRACT

A video encoding apparatus and method is provided. The video encoding apparatus includes a processor configured to encode video data according to a program, and a memory configured to store the program. The program performs intra prediction on a block of the video data, determines whether an optimum prediction method according to the intra prediction is a block non-division method, performs inter prediction according to a block division method corresponding to a prediction mode group in which a prediction mode of the block according to the intra prediction is included when the optimum prediction method is the block non-division method, selects a method in which an error is smallest among the block division methods applied in the inter prediction as an optimum division method, performs encoding according to the optimum division method.

### CROSS-REFERENCE TO RELATED APPLICATION

This application claims priority to and the benefit of Korean Patent Application No. 2015-0017599, filed on Feb. 4, 2015, the disclosure of which is incorporated herein by reference in its entirety.

### BACKGROUND

1. Field of the Invention

The present invention relates to video encoding technology, and more particularly, to technology of encoding a video through block division.

2. Discussion of Related Art

A block non-division method, a symmetric block division method, and an asymmetric block division method are technologies used for encoding a video signal, and are used for determining whether to divide an encoding target block and how to divide the encoding target block when generating a prediction signal. The block non-division method does not divide an encoding target block, and performs prediction. Unlike this method, the symmetric block division method and the asymmetric block division method divide an encoding target block into sub-blocks, and perform prediction. That is, the symmetric block division method divides the encoding target block into a plurality of sub-blocks having the same size, and the asymmetric block division block method divides the encoding target block into a plurality of sub-blocks having different sizes.

As an example of video encoding utilizing the asymmetric block division, the symmetric block division, and the block non-division technologies, there is high efficiency video coding (HEVC) which is a video encoding standard which is jointly established by ITU-T SG 16 WP 3 and ISO/IEC JTC 1/SC 29/WG 11. The HEVC divides a screen into coding tree units having the same size with respect to one sequence, and a size of the coding tree unit is one of 64×64, 32×32, or 16×16 pixels.

An operation of encoding a video signal finally determines whether to divide the encoding target block and how to divide the encoding target block after performing every prediction according to the block non-division method, the symmetric block division method, and the asymmetric block division method when performing prediction between screens (inter prediction). The encoding operation has an advantage of high compression efficiency, but has causes a time delay and an increase of power consumption, etc. due to excessive amounts of calculations.

### SUMMARY OF THE INVENTION

The present invention is directed to a video encoding apparatus and method which restrictively applies a block division method in the process of performing prediction.

According to one aspect of the present invention, there is provided a video encoding apparatus, including a processor configured to encode video data according to a program; and a memory configured to store the program, wherein the processor performs intra prediction on a block of the video data, determines whether an optimum prediction method according to the intra prediction is a block non-division method, performs inter prediction according to a block division method corresponding to a prediction mode group in which a prediction mode of the block according to the intra prediction is included when the optimum prediction method is the block non-division method, selects a method in which an error is smallest among the block division methods applied to the inter prediction as an optimum division method, performs encoding according to the optimum division method.

The processor may select the block division method corresponding to the prediction mode group in which the prediction mode of the block according to the intra prediction is included as a candidate block division method when the optimum prediction method is not the block non-division method, select the block division method corresponding to the prediction mode group on a sub-block of the block among candidate block division methods as a final block division method, and perform the inter prediction according to the final block division method.

The processor may select any one among sub-blocks determined in the intra prediction, select the block division method corresponding to the prediction mode group of the selected sub-block as a final block division method of the block, and perform the inter prediction according to the final block division method.

The processor may perform the inter prediction according to a horizontal direction block division method when the prediction mode group of the block according to the intra prediction is a horizontal direction group, perform the inter prediction according to a vertical direction block division method when the prediction mode group of the block is a vertical direction group, and perform the inter prediction using a block non-division method and every block division method when the prediction mode group of the block is not the horizontal direction group or the vertical direction group.

The processor may perform the prediction according to the block non-division method, perform the inter prediction according to a horizontal direction block division method when the prediction mode group of the block according to the intra prediction is a horizontal direction group, perform the inter prediction according to a vertical direction block division method when the prediction mode group of the block is a vertical direction group, and perform the inter prediction using every block division method when the prediction mode group of the block is not the horizontal direction group or the vertical direction group.

The processor may perform the prediction according to the block non-division method and a symmetric block division method, perform the inter prediction according to a horizontal direction asymmetric block division method when the prediction mode group of the block according to the intra prediction is a horizontal direction group, perform the inter prediction according to a vertical direction asymmetric block division method when the prediction mode group of the block is a vertical direction group, and perform the inter prediction using every asymmetric block division method when the prediction mode group of the block is not the horizontal direction group or the vertical direction group.

According to one aspect of the present invention, there is provided a video encoding method of encoding video data by a video encoding apparatus, including performing intra prediction on a block of the video data; determining whether an optimum prediction method according to the intra prediction is a block non-division method; performing inter prediction according to a block division method corresponding to a prediction mode group in which a prediction mode of the block according to the intra prediction is included when the optimum prediction method is the block non-division method; selecting a method in which an error is smallest among the block division methods applied to the inter prediction as an optimum division method; and performing encoding according to the optimum division method.

The video encoding method may further include selecting the block division method corresponding to the prediction mode group in which the prediction mode of the block according to the intra prediction is included as a candidate block division method when the optimum prediction method is not the block non-division method; selecting the block division method corresponding to the prediction mode group on a sub-block of the block among candidate block division methods as a final block division method; and performing the inter prediction according to the final block division method.

The video encoding method may further include selecting any one among sub-blocks determined in the intra prediction; selecting the block division method corresponding to the prediction mode group of the selected sub-block as a final block division method of the block; and performing the inter prediction according to the final block division method.

The performing of the inter prediction according to the block division method corresponding to the prediction mode group in which the prediction mode of the block according to the intra prediction is included when the optimum prediction method is the block non-division method, may include performing the inter prediction according to a horizontal direction block division method when the prediction mode group of the block according to the intra prediction is a horizontal direction group; performing the inter prediction according to a vertical direction block division method when the prediction mode group of the block is a vertical direction group; and performing the inter prediction using a block non-division method and every block division method when the prediction mode group of the block is not the horizontal direction group or the vertical direction group.

The performing of the inter prediction according to the block division method corresponding to the prediction mode group in which the prediction mode of the block according to the intra prediction is included when the optimum prediction method is the block non-division method may include performing the prediction according to the block non-division method; performing the inter prediction according to a horizontal direction block division method when the prediction mode group of the block according to the intra prediction is a horizontal direction group; performing the inter prediction according to a vertical direction block division method when the prediction mode group of the block is a vertical direction group; and performing the inter prediction using every block division method when the prediction mode group of the block is not the horizontal direction group or the vertical direction group.

The performing of the inter prediction according to the block division method corresponding to the prediction mode group in which the prediction mode of the block according to the intra prediction is included when the optimum prediction method is the block non-division method may include performing the prediction according to the block non-division method and a symmetric block division method; performing the inter prediction according to a horizontal direction asymmetric block division method when the prediction mode group of the block according to the intra prediction is a horizontal direction group; performing the inter prediction according to a vertical direction asymmetric block division method when the prediction mode group of the block is a vertical direction group; and performing the inter prediction using every asymmetric block division method when the prediction mode group of the block is not the horizontal direction group or the vertical direction group.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating a video encoding apparatus according to an embodiment of the present invention;

FIG. 2 is a flowchart for describing an operation in which a video encoding apparatus encodes video data according to an embodiment of the present invention;

FIG. 3 is a diagram illustrating a block predicted according to a block non-division method performed by a video encoding apparatus according to an embodiment of the present invention;

FIG. 4 is a diagram illustrating sub-blocks divided according to a symmetric block division method performed by a video encoding apparatus according to an embodiment of the present invention;

FIG. 5 is a diagram illustrating sub-blocks divided according to an asymmetric block division method performed by a video encoding apparatus according to an embodiment of the present invention;

FIG. 6 is a diagram illustrating a prediction mode and a prediction direction selected when a video encoding apparatus performs prediction in a screen (intra prediction) on video data according to an embodiment of the present invention;

FIG. 7 is a flowchart for describing an operation in which a video encoding apparatus performs prediction between screens (inter prediction) according to a block division method corresponding to a prediction mode group according to one embodiment of the present invention;

FIG. 8 is a flowchart for describing an operation in which a video encoding apparatus performs inter prediction according to a block division method corresponding to a prediction mode group according to another embodiment of the present invention; and

FIG. 9 is a flowchart for describing an operation in which a video encoding apparatus performs inter prediction according to a block division method corresponding to a prediction mode group according to still another embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications and equivalent and alternative forms can be made without departing from the spirit and scope of the invention.

Further, in this specification, when one component “transmits” a signal to another component, the one component may transmit the signal by directly connecting to the another component, but when being not specially described, it will be further understood that the signal may be transmitted through other intermediate components.

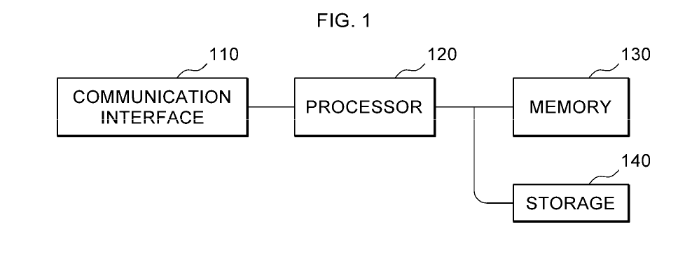

FIG. 1 is a block diagram illustrating a video encoding apparatus according to an embodiment of the present invention.

With reference to FIG. 1, a video encoding apparatus may include a communication interface 110, a processor 120, a memory 130, and a storage 140.

The communication interface 110 may receive video data from an external device using a predetermined protocol. Further, the communication interface 110 may transmit video data encoded by the processor 120 to the external device.

The processor 120 may encode the video data according to a program loaded in the memory 130.

The memory 130 may store a command for encoding the video data, and transmit a corresponding program to the processor 120 according to a request of the processor 120. In this case, the memory 130 may be a volatile memory.

The storage 140 may be a storage medium storing the program for encoding the video data. The memory 130 may load the command stored in the storage 140, and store the loaded command.

Hereafter, an operation in which the video encoding apparatus according to an embodiment of the present invention encodes the video data according to a predetermined program will be described in detail.

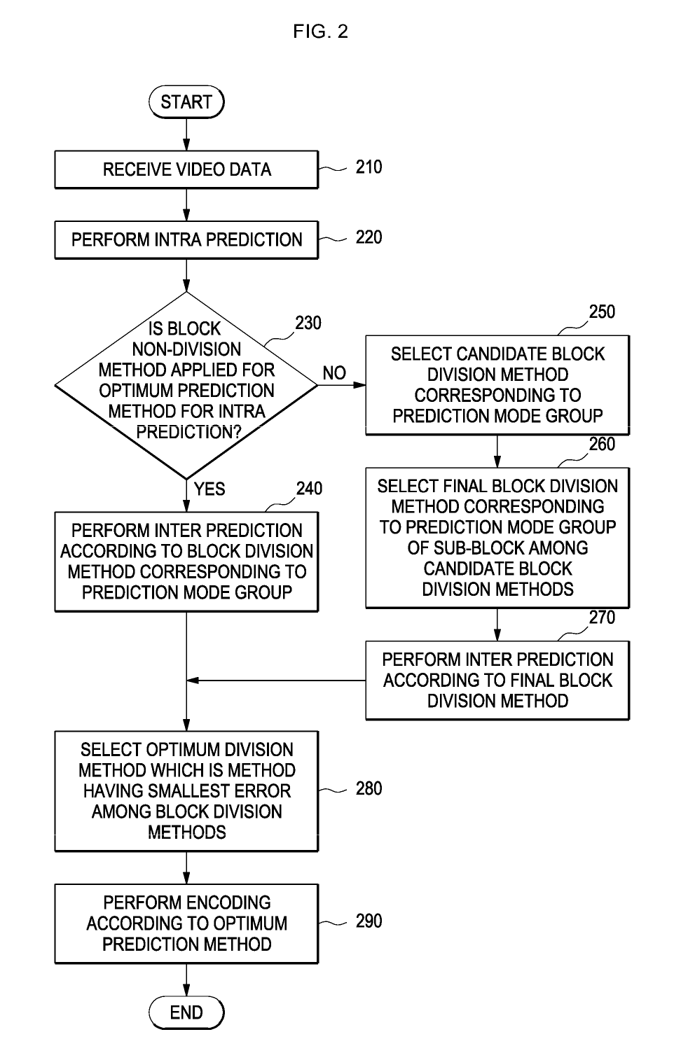

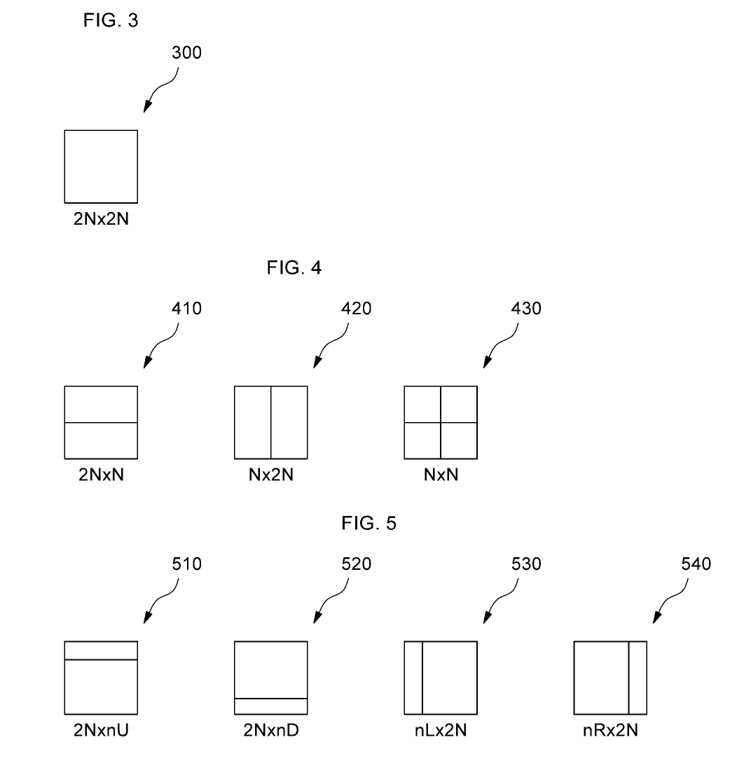

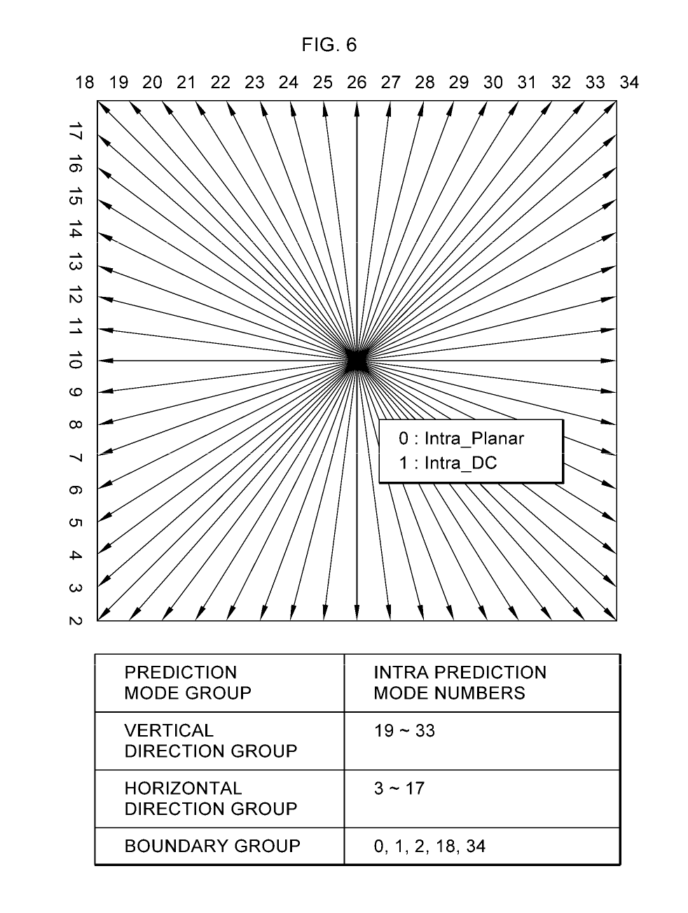

FIG. 2 is a flowchart for describing an operation in which a video encoding apparatus encodes video data according to an embodiment of the present invention, FIG. 3 is a diagram illustrating a block predicted according to a block non-division method performed by a video encoding apparatus according to an embodiment of the present invention, FIG. 4 is a diagram illustrating sub-blocks divided according to a symmetric block division method performed by a video encoding apparatus according to an embodiment of the present invention, FIG. 5 is a diagram illustrating sub-blocks divided according to an asymmetric block division method performed by a video encoding apparatus according to an embodiment of the present invention, and FIG. 6 is a diagram illustrating a prediction mode and a prediction direction selected when a video encoding apparatus performs prediction in a screen (intra prediction) on video data according to an embodiment of the present invention. While each operation which will be described below may be performed by each function unit included in the video encoding apparatus, a subject of each operation may be commonly called the video encoding apparatus for a clear and concise description. Further, a description related to a general data transmission operation among the communication interface 110, the processor 120, the memory 130, and the storage 140 in a computing device-related field will be omitted.

With reference to FIG. 2, in operation 210, the video encoding apparatus may receive the video data from the external device.

In operation 220, the video encoding apparatus may perform intra prediction on the video data. In this case, the video encoding apparatus may select a prediction mode for each block and at least one of whether to divide a block and an optimum block division method when optimum prediction is performed through the intra prediction. In this case, whether to divide the block may mean whether the optimum prediction is performed by the block non-division method, and the block division method may mean a block division method in which the optimum prediction is performed. The prediction mode may mean a method of predicting a pixel in a specific block, and in an embodiment of the present invention, there may be a total of 34 prediction modes as shown in FIG. 6, and some prediction modes may have directionality. The block non-division method may be a prediction method of performing the prediction without dividing a corresponding block into sub-blocks when dividing the video data into a block having a predetermined size. With reference to FIG. 3, for example, the video encoding apparatus may not divide a block 300 having a size of 2 N×2 N according to the block non-division method, and perform the prediction on the block 300. In this case, N is a natural number which is 1 or more.

In operation 230, the video encoding apparatus may determine whether the block non-division method is selected as an optimum prediction method in the intra prediction. In this case, the optimum prediction method may mean any one in which an error of the prediction results is a minimum among the plurality of block division methods and the block non-division methods applied to an intra prediction operation. That is, the video encoding apparatus may determine whether the optimum prediction is performed according to the block non-division method in the intra prediction operation performed in the operation 220.

When the block non-division method is selected in the intra prediction in the operation 230, the video encoding apparatus may perform prediction between screens (inter prediction) according to the block division method corresponding to the prediction mode group according to the intra prediction in operation 240. In this case, the block division method may include the symmetric block division method and the asymmetric block division method. The symmetric block division method may be a prediction method of dividing a corresponding block into a plurality of sub-blocks having the same size and performing the prediction on each sub-block, when dividing the video data into the predetermined size. With reference to FIG. 4, for example, when the block 300 having the size of 2 N×2 N is divided using the symmetric block division method, the symmetric block division method may be a method (411) of dividing the block 300 into two sub-blocks having sizes of 2 N×N, a method (412) of dividing the block 300 into two sub-blocks having sizes of N×2 N, and a method (413) of dividing the block 300 into four sub-blocks having a size of N×N. With reference to FIG. 5, for example, the asymmetric block division method may be a prediction method using sub-blocks according to a method (510) of dividing the block 300 into a sub-block having a size of 2 N×nU and a sub-block of a remaining region, a method (520) of dividing the block 300 into into a sub-block having a size of 2 N×nD and a sub-block of a remaining region, a method (530) of dividing the block 300 into a sub-block having a size of nL×2 N and a sub-block of a remaining region, or a method (540) of dividing the block 300 into a sub-block having a size of nR×2N and a sub-block of a remaining region. In this case, n, U, D, and R may be a natural number which is 1 or more.

In this case, the prediction mode group may be a group classifying a plurality of prediction modes according to directivity. The prediction mode group may be any one among a horizontal direction group, a vertical direction group, and a boundary group. As shown in FIG. 6, when the number of prediction modes is 34, prediction mode number 19 to prediction mode number 33 may be included in the horizontal direction group. Further, prediction mode number 3 to prediction mode number 17 may be included in the vertical direction group. Prediction mode number 0 to prediction mode number 2, and prediction mode number 18 and prediction mode number 34 may be included in the boundary group. In this case, the numbers for the prediction modes shown in FIG. 6 may be numbers set for each prediction mode according to the HEVC standard. Further, the horizontal direction group, the vertical direction group, and the boundary group may correspond to one or more block division methods. Hereinafter, an operation of performing the prediction using the block division method corresponding to the prediction mode group will be described in detail.

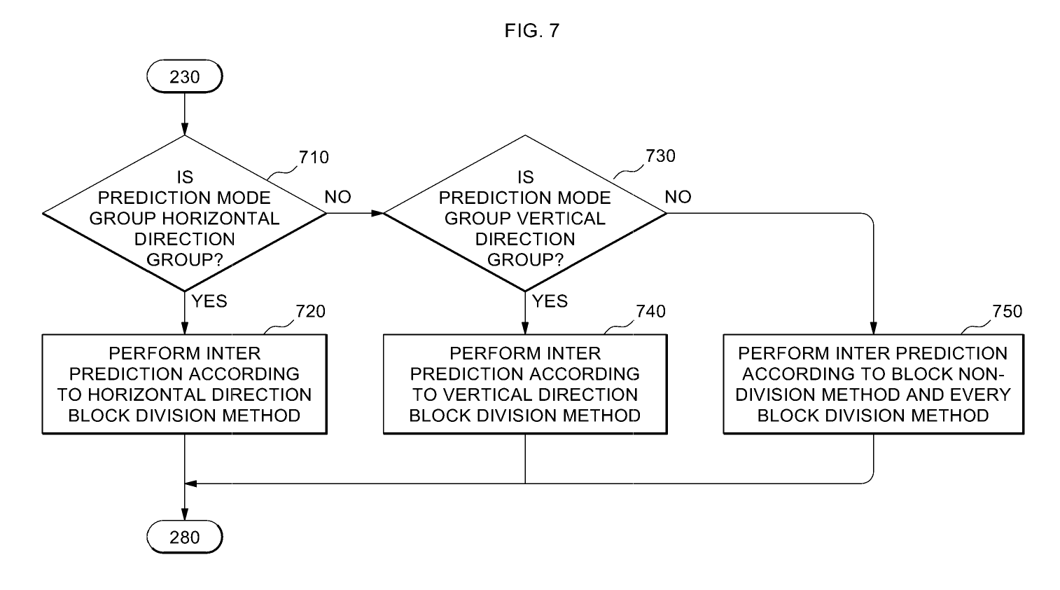

When the block non-division method is not selected for the intra prediction in the operation 230, the video encoding apparatus may select the block division method corresponding to the prediction mode on the block in the intra prediction as a candidate block division method in operation 250. In this case, the block division method corresponding to the prediction mode group may be the same as the block division method performed in the prediction operation of the operation 240 described above. That is, in each operation which will be described below with reference to FIGS. 7 to 9, the candidate block division method may be selected using the same operation as the operation of selecting the block division method corresponding to the prediction mode group. Although each operation, which will be described with reference to FIGS. 7 to 9, performs the prediction using the selected block division method, only the operation of setting the block division method as the candidate block division method may be performed in the operation 230.

In operation 260, the video encoding apparatus may select the block division method corresponding to the prediction mode group of the sub-block according to intra prediction among the candidate block division methods as a final block division method.

In operation 270, the video encoding apparatus may perform the inter prediction according to the final block division method.

In operation 280, the video encoding apparatus may set the block division method in which an error of prediction results is smallest among the block division methods applied to the inter prediction as an optimum division method. That is, the video encoding apparatus may compare a difference between a value predicted according to each block division method and a value of the video data, and set the block division method in which the difference is the smallest as the optimum division method.

In operation 290, the video encoding apparatus may perform encoding according to the optimum prediction method.

In this case, the operations 260 and 270 described above may be changed into an operation of selecting any one of sub-blocks determined in the intra prediction and setting the block division method corresponding to the prediction mode group of the selected sub-block as the block division method of the block. For example, the video encoding apparatus may select the sub-block of a predetermined position in the block, and set the block division method corresponding to the prediction mode group of the selected sub-block as the block division method of a corresponding block.

The operation 240 described above may be performed according to three embodiments. Hereinafter, an operation of performing the inter prediction according to the block division method corresponding to the prediction mode group according to each embodiment will be described in detail with reference to FIGS. 7 to 9.

FIG. 7 is a flowchart for describing an operation in which a video encoding apparatus performs prediction between screens (inter prediction) according to a block division method corresponding to a prediction mode group according to an embodiment of the present invention.

With reference to FIG. 7, in operation S10, the video encoding apparatus may determine whether the prediction mode group of the block according to the intra prediction in the screen is the horizontal direction group.

When the prediction mode group is the horizontal direction group in the operation 710, the video encoding apparatus may perform the inter prediction according to a horizontal direction block division method in operation 720. In this case, the horizontal direction block division method may be the block division method of dividing the block into the sub-blocks in which a horizontal length is greater than a vertical length, as shown by 410 of FIGS. 4 and 510 and 520 of FIG. 5.

When the prediction mode group is not the horizontal direction group in the operation 710, the video encoding apparatus may determine whether the prediction mode group of the block according to the intra prediction is the vertical direction group in operation 730.

When the prediction mode group is the vertical direction group in the operation 730, the video encoding apparatus may perform the inter prediction according to a vertical direction block division method in operation 740. In this case, the vertical direction block division method may be the block division method of dividing the block into the sub-blocks in which the vertical length is greater than the horizontal length, as shown by 420 of FIGS. 4 and 530 and 540 of FIG. 5.

When the prediction mode group is the vertical direction group in operation the 730, the video encoding apparatus may perform the inter prediction using the block non-division method and every block division method in operation 750.

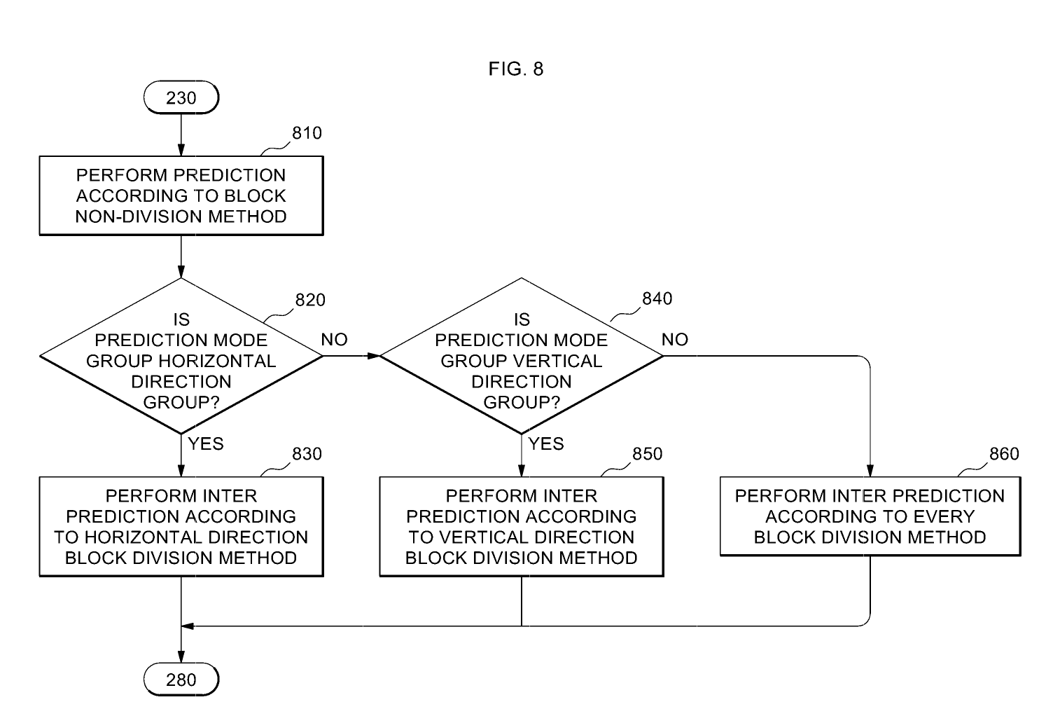

FIG. 8 is a flowchart for describing an operation in which a video encoding apparatus performs inter prediction according to a block division method corresponding to a prediction mode group according to another embodiment of the present invention.

With reference to FIG. 8, in operation 810, the video encoding apparatus may perform the prediction according to a block non-division method.

In operation 820, the video encoding apparatus may determine whether the prediction mode group of the block according to the intra prediction is the horizontal direction group.

When the prediction mode group is the horizontal direction group in the operation 820, the video encoding apparatus may perform the inter prediction according to the horizontal direction block division method in operation 830.

When the prediction mode group is not the horizontal direction group in the operation 820, the video encoding apparatus may determine whether the prediction mode group of the block according to the intra prediction is the vertical direction group in operation 840.

When the prediction mode group is the vertical direction group in the operation 840, the video encoding apparatus may perform the inter prediction according to the vertical direction block division method in operation 850.

When the prediction mode group is not the vertical direction group in the operation 840, the video encoding apparatus may perform the inter prediction using every block division method in operation 860.

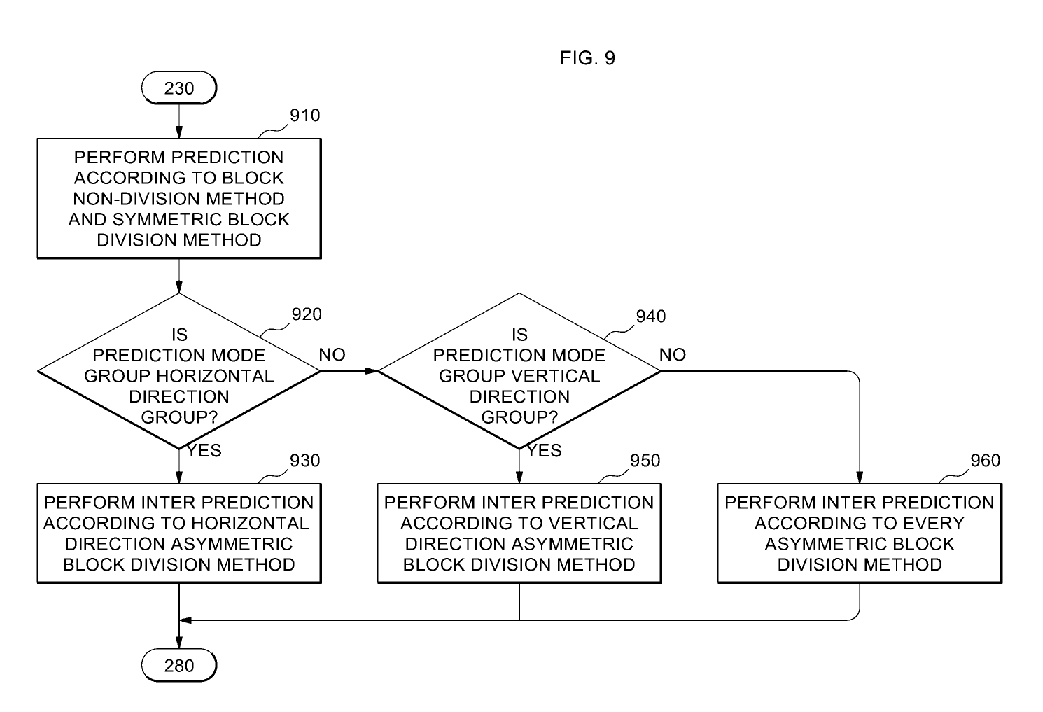

FIG. 9 is a flowchart for describing an operation in which a video encoding apparatus performs inter prediction according to a block division method corresponding to a prediction mode group according to still another embodiment of the present invention.

With reference to FIG. 9, in operation 910, the video encoding apparatus may perform the prediction according to the block non-division method and the symmetric block division method.

In operation 920, the video encoding apparatus may determine whether the prediction mode group of the block according to the intra prediction is the horizontal direction group.

When the prediction mode group is the horizontal direction group in the operation 920, the video encoding apparatus may perform the inter prediction according to a horizontal direction asymmetric block division method in operation 930. The horizontal direction asymmetric block division method may be the asymmetric block division method of dividing the block into the sub-blocks in which the horizontal length is greater than the vertical length, as shown by 510 and 520 of FIG. 5.

When the prediction mode group is not the horizontal direction group in the operation 920, the video encoding apparatus may determine whether the prediction mode group of the block according to the intra prediction is the vertical direction group in operation 940.

When the prediction mode group is the vertical direction group in the operation 940, the video encoding apparatus may perform the inter prediction according to a vertical direction asymmetric block division method in operation 950. The vertical direction asymmetric block division method may be the asymmetric block division method of dividing the block into the sub-blocks in which the vertical length is greater than the horizontal length, as shown by 530 and 540 of FIG. 5.

When the prediction mode group is not the vertical direction group in the operation 940, the video encoding apparatus may perform the inter prediction using every asymmetric block division method in operation 960.

Accordingly, the video encoding apparatus according to embodiments of the present invention may reduce a load generated in the prediction operation of the encoding since the prediction is performed on only some of the asymmetric block division methods.

According to the embodiments of the present invention described above, the load generated in the process of performing the prediction on each block of the video data can be reduced.

The present invention is described based on the above-described exemplary embodiments. It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A video encoding apparatus, comprising:
a processor configured to encode video data according to a program; and
a memory configured to store the program,
wherein the processor performs intra prediction on a block of the video data, determines whether an optimum prediction method according to the intra prediction is a block non-division method, performs inter prediction according to a block division method corresponding to a prediction mode group in which a prediction mode of the block according to the intra prediction is included when the optimum prediction method is the block non-division method, selects a method in which an error is smallest among the block division methods applied to the inter prediction as an optimum division method, and performs encoding according to the optimum division method.

2. The video encoding apparatus of claim 1, wherein the processor selects the block division method corresponding to the prediction mode group in which the prediction mode of the block according to the intra prediction is included as a candidate block division method when the optimum prediction method is not the block non-division method, selects the block division method corresponding to the prediction mode group on a sub-block of the block among candidate block division methods as a final block division method, and performs the inter prediction according to the final block division method.

3. The video encoding apparatus of claim 1, wherein, the processor selects any one among sub-blocks determined in the intra prediction, selects the block division method corresponding to the prediction mode group of the selected sub-block as a final block division method of the block, and performs the inter prediction according to the final block division method.

4. The video encoding apparatus of claim 1, wherein the processor performs the inter prediction according to a horizontal direction block division method when the prediction mode group of the block according to the intra prediction is a horizontal direction group, performs the inter prediction according to a vertical direction block division method when the prediction mode group of the block is a vertical direction group, and performs the inter prediction using a block non-division method and every block division method when the prediction mode group of the block is not the horizontal direction group or the vertical direction group.

5. The video encoding apparatus of claim 1, wherein the processor performs the prediction according to the block non-division method, performs the inter prediction according to a horizontal direction block division method when the prediction mode group of the block according to the intra prediction is a horizontal direction group, performs the inter prediction according to a vertical direction block division method when the prediction mode group of the block is a vertical direction group, and performs the inter prediction using every block division method when the prediction mode group of the block is not the horizontal direction group or the vertical direction group.

6. The video encoding apparatus of claim 1, wherein the processor performs the prediction according to the block non-division method and a symmetric block division method, performs the inter prediction according to a horizontal direction asymmetric block division method when the prediction mode group of the block according to the intra prediction is a horizontal direction group, performs the inter prediction according to a vertical direction asymmetric block division method when the prediction mode group of the block is a vertical direction group, and performs the inter prediction using every asymmetric block division method when the prediction mode group of the block is not the horizontal direction group or the vertical direction group.

7. A video encoding method of encoding video data by a video encoding apparatus, comprising:
performing intra prediction on a block of the video data;
determining whether an optimum prediction method according to the intra prediction is a block non-division method;
performing inter prediction according to a block division method corresponding to a prediction mode group in which a prediction mode of the block according to the intra prediction is included when the optimum prediction method is the block non-division method;
selecting a method in which an error is smallest among the block division methods applied to the inter prediction as an optimum division method; and
performing encoding according to the optimum division method.

8. The video encoding method of claim 7, further comprising:
selecting the block division method corresponding to the prediction mode group in which the prediction mode of the block according to the intra prediction is included as a candidate block division method when the optimum prediction method is not the block non-division method;
selecting the block division method corresponding to the prediction mode group on a sub-block of the block among candidate block division methods as a final block division method; and
performing the inter prediction according to the final block division method.

9. The video encoding method of claim 7, further comprising:
selecting any one among sub-blocks determined in the intra prediction;
selecting the block division method corresponding to the prediction mode group of the selected sub-block as a final block division method of the block; and
performing the inter prediction according to the final block division method.

10. The video encoding method of claim 7, wherein the performing of the inter prediction according to the block division method corresponding to the prediction mode group in which the prediction mode of the block according to the intra prediction is included when the optimum prediction method is the block non-division method, comprises:
performing the inter prediction according to a horizontal direction block division method when the prediction mode group of the block according to the intra prediction is a horizontal direction group;
performing the inter prediction according to a vertical direction block division method when the prediction mode group of the block is a vertical direction group; and
performing the inter prediction using a block non-division method and every block division method when the prediction mode group of the block is not the horizontal direction group or the vertical direction group.

11. The video encoding method of claim 7, wherein the performing of the inter prediction according to the block division method corresponding to the prediction mode group in which the prediction mode of the block according to the intra prediction is included when the optimum prediction method is the block non-division method, comprises:
performing the prediction according to the block non-division method;
performing the inter prediction according to a horizontal direction block division method when the prediction mode group of the block according to the intra prediction is a horizontal direction group;
performing the inter prediction according to a vertical direction block division method when the prediction mode group of the block is a vertical direction group; and
performing the inter prediction using every block division method when the prediction mode group of the block is not the horizontal direction group or the vertical direction group.

12. The video encoding method of claim 7, wherein the performing of the inter prediction according to the block division method corresponding to the prediction mode group in which the prediction mode of the block according to the intra prediction is included when the optimum prediction method is the block non-division method, comprises:
performing the prediction according to the block non-division method and a symmetric block division method;
performing the inter prediction according to a horizontal direction asymmetric block division method when the prediction mode group of the block according to the intra prediction is a horizontal direction group;
performing the inter prediction according to a vertical direction asymmetric block division method when the prediction mode group of the block is a vertical direction group; and
performing the inter prediction using every asymmetric block division method when the prediction mode group of the block is not the horizontal direction group or the vertical direction group.
